(19) United States
(12) Patent Application Publication
(10) Pub. No.: US 2020/0256242 A1
(43) Pub. Date: Aug. 13, 2020

(54) DIVIDED EXHAUST BOOST TURBOCHARGER

(71) Applicant: BorgWarner Inc., Auburn Hills, MI (US)

(72) Inventors: David B. ROTH, Groton, NY (US); Christopher P. THOMAS, Commerce, MI (US)

(21) Appl. No.: 15/780,815

(22) PCT Filed: Nov. 18, 2016
(86) PCT No.: PCT/US2016/062686

§ 371 Date: Jun. 1, 2018

Related U.S. Application Data
(60) Provisional application No. 62/262,141, filed on Dec. 2, 2015.

(51) Int. Cl. F02B 37/12; F02B 39/16; F01D 17/12

(52) U.S. Cl. CPC F02B 37/12; F01D 17/12; F02B 39/16

(57) ABSTRACT

A number of variations may include a product that may include a valve system having a first valve plate constructed and arranged to selectively open and close a blowdown passage, a second valve plate constructed and arranged to selectively open and close a scavenge passage, and wherein the first plate and second plate have a common axis of rotation.

### CROSS-REFERENCE TO RELATED APPLICATIONS

This application claims the benefit of the U.S. Provisional Application No. 62/262,141 filed Dec. 2, 2015.

### TECHNICAL FIELD

The field to which the disclosure generally relates to includes systems including turbochargers.

### BACKGROUND

Turbochargers may be used to force air into engines.

### SUMMARY OF ILLUSTRATIVE VARIATIONS

A number of variations may include a product that may include a valve system having a first valve plate constructed and arranged to selectively open and close a blowdown passage, a second valve plate constructed and arranged to selectively open and close a scavenge passage, and wherein the first plate and second plate have a common axis of rotation.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a product including a valve system according to a number of variations.

FIG. 2 is a schematic illustration of a product including a valve system according to a number of variations.

FIG. 3 is a schematic sectional illustration of a valve system including three valve plates constructed and arranged to selectively allow both scavenge exhaust gas and blowdown exhaust gas to flow past the three plates according to a number of variations.

FIG. 4 is a schematic sectional illustration of a valve system including three plates wherein a first plate is positioned to allow scavenger exhaust gas to flow thereby, a second plate constructed and arranged to allow blowdown exhaust gas to flow thereby, and a third plate constructed and arranged to open a wastegate crossover passage between a blowdown conduit and a scavenge conduit according to a number of variations.

FIG. 5 is a schematic sectional illustration of a valve system wherein a first valve plate is positioned to restrict flow of scavenge gas through a passage in the scavenge conduit, a second plate is positioned to allow blowdown exhaust gas to flow thereby, and a third plate positioned to close a wastegate crossover passage between a blowdown conduit and a scavenge conduit according to a number of variations.

FIG. 6 is a schematic sectional illustration of a valve system wherein a first plate is positioned to allow scavenge exhaust gas to pass thereby, a second plate is positioned to restrict the flow of blowdown exhaust gas in the blowdown conduit, and a third plate is positioned to close a wastegate crossover passage between a blowdown conduit and a scavenge conduit according to a number of variations.

FIG. 7 is a schematic side view with portions removed illustrating a valve system or assembly is an integral part of a turbine housing or is directly connected to a turbine housing according to a number of variations.

FIG. 8 is a schematic end view with portions removed illustrating a valve system or assembly is an integral part of a turbine housing or is directly connected to a turbine housing according to a number of variations.

FIG. 9 is a perspective view of a scavenge manifold and blowdown manifold connected to a flange for mounting on an engine according to a number of variations.

### DETAILED DESCRIPTION OF ILLUSTRATIVE VARIATIONS

The following description of the variations is merely illustrative in nature and is in no way intended to limit the scope of the invention, its application, or uses.

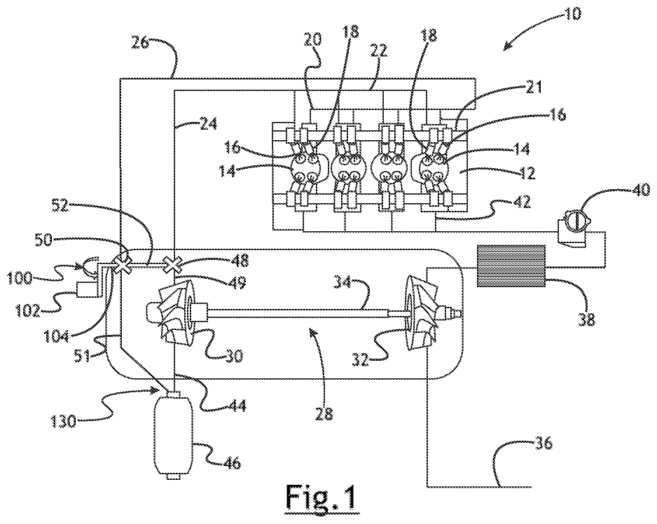

A number of variations are illustrated in FIG. 1 and may include a product or system 10 which may include a valve system 100 including a first valve 48 and a second valve 50 having a common axis of rotation. The system 10 may include an engine 12 having a plurality of cylinders formed therein and in which a piston travels in a respective cylinder typically from a bottom dead center to a top dead center position. A plurality of blowdown valves 16 and scavenge valves 18 may be provided and operatively connected to the engine 12. A scavenge manifold 20 may be constructed and arranged to collect scavenge discharge exhaust gas from a plurality of the cylinders 14. A blowdown manifold 22 may be constructed and arranged to collect blowdown exhaust gas from a plurality of the cylinders 14. A blowdown conduit or pipe 24 may be operatively connected to the blowdown manifold 22 and may connect to a turbine 30 of a turbocharger 28. The turbocharger 28 may include a compressor 32 which may be connected to the turbine 30 by a shaft 34 or by other means, for example but not limited to, when the turbocharger is an electronic turbocharger. A scavenger conduit or pipe 26 may be connected to the scavenge manifold 20 and to a pollution control device 46 such as, but not limited to, a catalyst, directly or by way of a turbine exit conduit or pipe 44 which is connected to the catalyst 46. A valve system 100 may include a first valve 48 constructed and arranged to control the flow of blowdown exhaust gas through the turbine 30. A second valve 50 may be constructed and arranged to control the flow of exhaust gas through the scavenge conduit or pipe 26. One or more actuators 102 may be operatively connected to the first valve 48 and second valve 50. In a number of variations, the first valve 48 and second valve 50 have a common axis of rotation and may be moved or rotated by a single actuator. Fresh air may flow through an intake conduit or pipe 36 to the compressor 32, through an air charge cooler 38, past an intake throttling valve 40, into an intake manifold 42, and into cylinders 14 of the engine 12. In a number of variations, the engine may be equipped with a concentric-cam/phaser to control the blowdown valve 16 and scavenger valves 18.

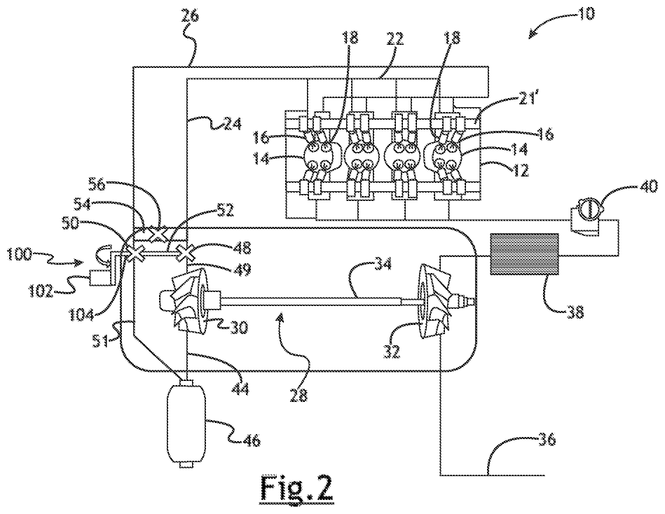

A number of variations are illustrated in FIG. 2 which may include a product 10. An arrangement similar to that shown in FIG. 1, but wherein the engine 12 is equipped with a non-concentric cam/phaser 21′. A wastegate conduit 54 provides a wastegate cross over passage to allow exhaust gas in the blowdown conduit 24 to crossover and flow into the scavenger conduit 26. A wastegate valve 65 may be provided in the wastegate conduit 54 to control exhaust gas flow therethrough.

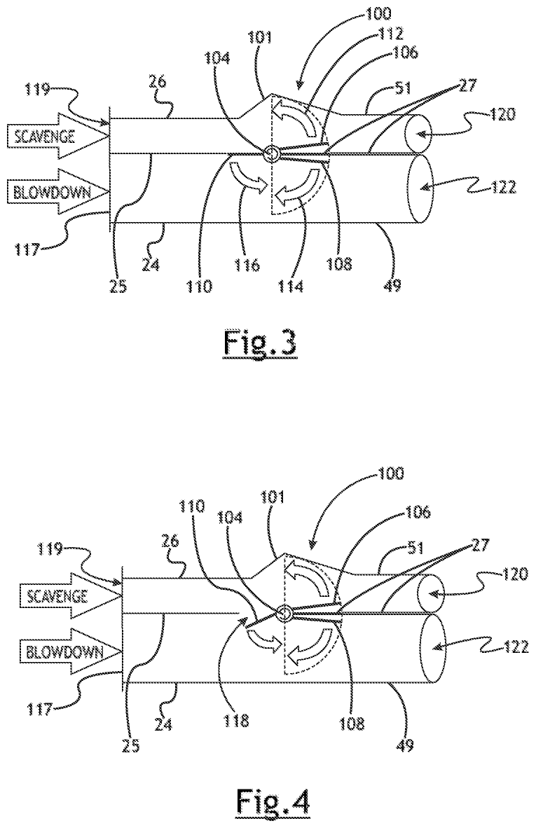

A number of variations are illustrated in FIG. 3 and may include a valve system 100 positioned between the scavenger conduit 26 and the blowdown conduit 24, and may include a first valve plate 106, second valve plate 108, and third valve plate 110. The first valve plate 106, second valve plate 108, and third valve plate 110 may share a common axis of rotation. In a number of variations, one or more shafts 104 may be connected to one or more of the first valve plate 106, second valve plate 108, and/or third valve plate 110. Concentric shafts 104 may be provided to independently move each of the first valve plate 106, second valve plate 108, or third valve plate 110. In a number of other variations, a single shaft may be provided and a number of lost motion mechanisms may be utilized to control the movement of the first valve plate 106, second valve plate 108, and third valve plate 110. The first valve plate 106 may be constructed and arranged to move from a first position wherein the first valve plate 106 is adjacent to a common wall 27 shared between the scavenger conduit 26, 51 and the blowdown conduit 24, 49. In the first position, the first valve plate 106 is such that the scavenge conduit 26 is fully open, at least 95% open, at least 90% open, or at least 85% open. The first valve plate 106 may be moved to a second position which restricts the flow of exhaust gas through the scavenge conduit 26, 51, or to a position, for example, wherein the first plate 106 is perpendicular to the common wall 27 and the first valve plate 106 fully closes the scavenge conduit 26, closes at least 90% of the scavenge conduit 26, or closes at least 80% of the scavenge conduit 26.

The second valve plate 108 may be positioned in a first position adjacent the common wall 27 so that the blowdown conduit 24, 49 (or passage 117) is fully open, at least 95% open, at least 90% open, at least 85% open. The second valve plate 108 may be moved to a second position perpendicular to the common wall 27 wherein the blowdown conduit 24, 49 is completely closed, or 90% closed, or 80% closed.

The third valve plate 110 may be moved from a first position parallel to the common wall 27 or so that a wastegate crossover passage 118 is blocked by the third valve plate 110. In a number of variations, the third valve plate 110 may be moved to a second position away from a line parallel with the common wall 27 to provide an opening or wastegate crossover passage 118 between the scavenger conduit 26 and the blowdown conduit 24 to allow blowdown gas to cross over into the scavenger conduit 26, 51.

FIG. 3 illustrates the valve system 100 in the neutral position with the first valve plate 106 and second valve plate 108 adjacent the common wall 27 between the scavenger conduit 26, 51 and the blowdown conduit 24, 49, and wherein the third valve plate 110 blocks the wastegate crossover passage 118 between the blowdown conduit 24 and the scavenger conduit 26. In this arrangement, engine boost using the turbocharger may be controlled by modulation of the exhaust cam phaser.

Referring now to FIG. 4, in a number of variations, in a system which does not include a concentric cam/phaser, the third valve plate 110 may be used to provide a wastegate to control boost at moderate to high loads. The third valve plate 110 may be moved away from a first position parallel with the common wall 27 to provide a wastegate crossover passage 118, allowing blowdown exhaust gas to cross over into the scavenge conduit 26, 51, thereby bypassing the turbocharger turbine 30. In a number of variations, while the third plate 110 is moved to a second position to provide a wastegate crossover passage 118, the first valve plate 106, and optionally the second valve plate 108, may be moved to be positioned adjacent the common wall 27 between the scavenge conduit 26, 51 and blowdown conduit 24, 49.

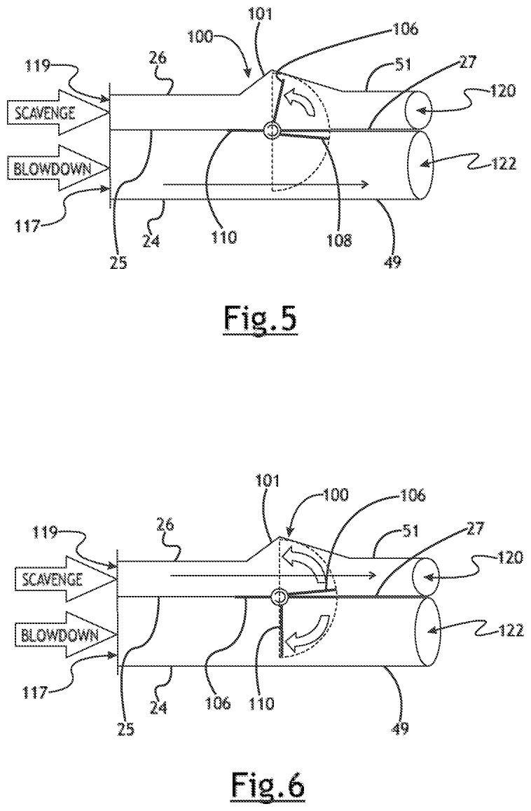

FIG. 5 illustrates a number of variations wherein, for example, in situations where a low-speed boost enhancement is needed, the first valve plate 106 may be moved from a first position adjacent the common wall 27 to a position which at least partially restricts the flow of exhaust gas through the scavenge conduit 26, 51, thereby causing more exhaust gas from the engine to flow through the blowdown conduit 24, 29 to the turbocharger turbine 30 thereby increasing the turbocharger boost. In a number of variations, the first valve plate 106 may be moved to a second position which completely blocks the flow of exhaust gas through the scavenge conduit 26, 51, or to a position which blocks 95% of the scavenge passage 119, 90% of the scavenge passage 119, 90% of the scavenge passage 119, or 85% of the scavenge passage 119. The second valve plate 108 may be positioned adjacent the common wall 27 so that the blowdown conduit is fully open.

A number of variations are illustrated in FIG. 6, and may include controlling the valve system 100 during, for example, a cold start to restrict or eliminate the flow of exhaust gas through the blowdown conduit 24, 49 and through the turbocharger turbine 30. In a number of variations during a cold start, the second valve plate 108 may be moved to a position which restricts or completely closes the blowdown passage 117. The first valve plate 106 may be positioned adjacent the common wall 27 so that the scavenge passage is fully open to allow exhaust flow through the scavenge passage 119, thereby bypassing the turbocharger 30. The third valve plate may be in a position parallel to the common wall 27 to block the crossover passage between the blowdown conduit 24 and scavenge conduit 26. Blocking or restricting flow through the blowdown conduit 24 and causing the scavenge passage to be fully open results in all of the exhaust gas to bypass the turbine and flow directly to the pollution control device 46 such as a catalyst to quickly light off the catalyst, for example during a cold start. In a number of other variations such a valve arrangement may be used to cause maximum exhaust flow through the scavenge conduit 26 and into a particulate trap to burn out particulate matter therein.

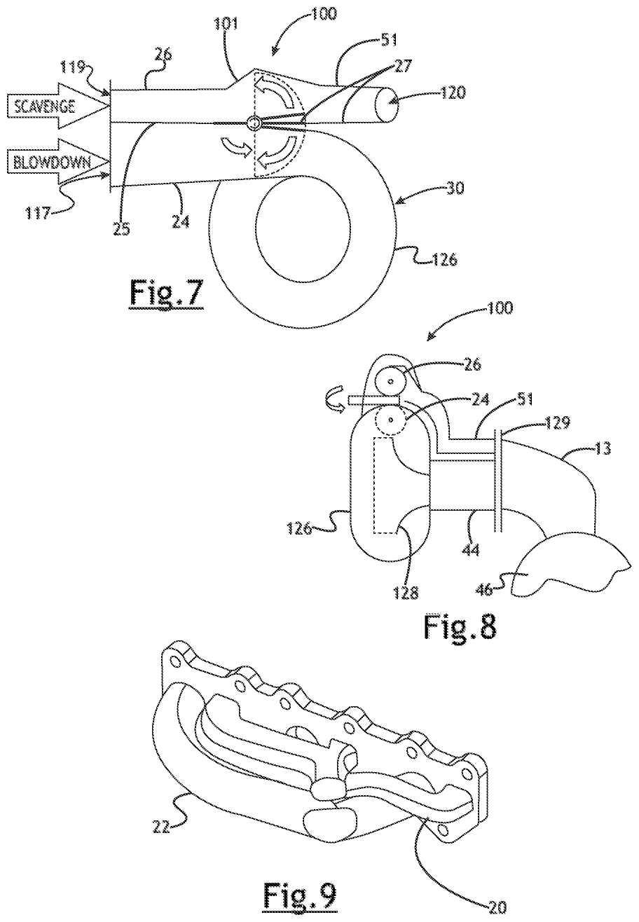

FIG. 7 is a schematic side view with portions removed illustrating a valve system or assembly 100 is an integral part of a turbine housing 126 or is directly connected to a turbine housing 126 according to a number of variations.

FIG. 8 is a schematic end view with portions removed illustrating a valve system or assembly 100 is an integral part of a turbine housing 126 or is directly connected to a turbine housing 126 having a turbine wheel therein. A turbine exit pipe 44 and a portion 51 of the scavenge conduit may be attached by flanges 129 to combined blowdown and scavenge conduit 130 that connects to the pollution control device 46 according to a number of variations.

FIG. 9 is a perspective view of a scavenge manifold and blowdown manifold connected to a flange for mounting on an engine according to a number of variations.

The valve system 100 may include a valve housing that receives the first valve plat 106, second valve palate 108 and third valve plate 110. The valve housing 101 may be flanged to the scavenge conduit 26 and the blowdown conduit 24 on the inlet side so that passages 119 and 117 are connected to inlet ports of the housing 101, and flanged to the another portion 51 of the scavenge conduit and another portion 49 of the blowdown conduit so that passages 120 and 122 are connected to outlet portion of the housing 101. In a number of variations an outlet of the housing 101 may flow directly into the turbine housing 126.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a valve housing including a blowdown conduit having a passage, a scavenge conduit having a passage, a first valve plate constructed and arranged to control the flow through the blowdown passage, a second valve plate constructed and arranged to control the flow through the scavenge passage, the first valve plate and second valve plate constructed and arranged to have a common axis of rotation.

Variation 2 may include product as set forth in Variation 1 further comprising a single actuator connected to the first valve plate and second valve plate to rotate the first valve plate and second valve plate.

Variation 3 may include a product comprising: a valve system including a blowdown conduit having a blowdown exhaust gas passage, a scavenge conduit having a scavenge exhaust gas conduit, and a wastegate passage formed between the blowdown conduit and the scavenge conduit, a first valve plate constructed and arranged to control the flow of blowdown exhaust gas through the blowdown exhaust gas passage, a second valve plate constructed and arranged to control the flow of scavenge exhaust gas through the scavenge exhaust gas passage, and a third valve plate constructed and arranged to control the flow of exhaust gas from the blowdown exhaust gas passage through the wastegate passage and into the scavenge exhaust gas passage.

Variation 4 may include a product as set forth in Variation 3 wherein the first valve plate, second valve plate and third valve plate are constructed and arranged to have a common axis of rotation.

Variation 5 may include a product as set forth in Variations 3-4 further comprising a single actuator connected to the first valve plate, second valve plate and third valve plate to control the rotation thereof.

Variation 6 may include a product as set forth in Variation 3-5 wherein the blowdown conduit and scavenge conduit have a common wall.

Variation 7 may include a product as set forth in Variation 6 wherein the wastegate crossover passage is formed in the common wall.

Variation 8 may include a product as set forth in Variations 1-2 further comprising a vehicle engine having a non-concentric-cam/phaser.

Variation 9 may include a product as set forth in Variation 3-7 further comprising a vehicle engine that does not have a concentric-cam/phaser.

Variation 10 may include a method comprising: providing a product comprising a scavenge conduit and a blowdown conduit, wherein the scavenge conduit and blowdown conduit have a common wall, a valve system received between the scavenge conduit and the blowdown conduit, and a wastegate crossover passage formed between the scavenge conduit and blowdown conduit, the valve system including a first valve plate constructed and arranged to control the flow of exhaust gas through the scavenge conduit, a second valve plate constructed and arranged to control the flow of exhaust gas through the blowdown conduit, and a third valve plate constructed and arranged to control the flow of wastegate crossover exhaust from the blowdown conduit into the scavenger conduit, the first valve plate, second valve plate and third valve plate having a common axis of rotation, and controlling the valve system comprising at least one of:

(a) moving the first valve plate to a position adjacent the common wall and so that the scavenger conduit passage is fully open, moving the second valve plate to a position adjacent the common wall so that the blowdown passage is fully open, and moving the third plate to completely close the wastegate crossover passage between the blowdown conduit and scavenge conduit;
(b) moving the first valve plate to a position adjacent the common wall so the scavenge passage is completely open, moving the second valve plate to a position adjacent the common wall, and moving the third valve plate to a position away from being parallel with the common wall to at least partially open the wastegate crossover passage;
(c) moving the first valve plate to at least partially block the scavenge conduit passage, moving the second valve plate to a position adjacent the common wall so that the blowdown passage is completely open and moving the third valve plate to block the crossover wastegate passage between the blowdown conduit and the scavenge conduit; or
(d) moving the first valve plate to a position adjacent the common wall so that the scavenge conduit passage is completely open, moving the second valve plate to at least partially restrict the flow of exhaust through the blowdown conduit passage, and moving the third valve plate to close the wastegate crossover passage between the blowdown conduit and the scavenge conduit.

Variation 11 may include a method as set forth in Variation 10 method as set forth in claim 10 further comprising a vehicle engine including a plurality of cylinders, a plurality of scavenge valves and a plurality of blowdown valves, wherein one of the plurality of scavenge valves and one of the plurality of blowdown valves is connected to one of the plurality of cylinders, a blowdown manifold connected to the plurality of blowdown valves and the blowdown conduit connected to the blowdown manifold, a scavenger manifold connected to the plurality of scavenge valves and the scavenge conduit connected to the scavenge manifold, the blowdown conduit connected to a turbine of a turbocharger, the scavenge manifold bypassing the turbine and connected to the blowdown conduit downstream of the turbine or connected to a pollution control device, an air intake conduit connected to a compressor of the turbocharger, and the air conduit connected from the compressor to an air intake manifold operatively connected to the plurality of cylinders, the engine including a non-concentric cam/phaser, and controlling the amount of air intake boost from the turbine by modulating the non-concentric/cam phaser when the first valve plate is in a position adjacent the common wall, the second valve plate is in a position adjacent the common wall and wherein the third valve plate closes the wastegate crossover passage between the blowdown conduit and the scavenge conduit.

Variation 12 may include a method as set forth in Variations 10-11 wherein the controlling the valve system comprising moving the first valve plate to a position adjacent the common wall and so that the scavenger conduit passage is fully open, moving the second valve plate to a position adjacent the common wall so that the blowdown passage is fully open, and moving the third plate to completely close the wastegate crossover passage between the blowdown conduit and scavenge conduit.

Variation 13 may include a method as set forth in Variations 10-11 wherein the controlling the valve system comprising moving the first valve plate to a position adjacent the common wall so the scavenge passage is completely open, moving the second valve plate to a position adjacent the common wall, and moving the third valve plate to a position away from being parallel with the common wall to at least partially open the wastegate crossover passage.

Variation 14 may include a method as set forth in Variations 10-11 wherein the controlling the valve system comprising moving the first valve plate to at least partially block the scavenge conduit passage, moving the second valve plate to a position adjacent the common wall so that the blowdown passage is completely open and moving the third valve plate to block the crossover wastegate passage between the blowdown conduit and the scavenge conduit.

Variation 15 may include a method as set forth in Variations 10-11 wherein the controlling the valve system comprising moving the first valve plate to a position adjacent the common wall so that the scavenge conduit passage is completely open, moving the second valve plate to at least partially restrict the flow of exhaust through the blowdown conduit passage, and moving the third valve plate to close the wastegate crossover passage between the blowdown conduit and the scavenge conduit.

The above description of select variations within the scope of the invention is merely illustrative in nature and, thus, variations or variants thereof are not to be regarded as a departure from the spirit and scope of the invention.

What is claimed is:

1. A product comprising:
a valve housing including a blowdown conduit having a passage, a scavenge conduit having a passage,
a first valve plate constructed and arranged to control the flow through the blowdown passage, a second valve plate constructed and arranged to control the flow through the scavenge passage, the first valve plate and second valve plate constructed and arranged to have a common axis of rotation.

2. A product as set forth in claim 1 further comprising a single actuator connected to the first valve plate and second valve plate to rotate the first valve plate and second valve plate.

3. A product comprising:
a valve system including a blowdown conduit having a blowdown exhaust gas passage, a scavenge conduit having a scavenge exhaust gas conduit, and a wastegate passage formed between the blowdown conduit and the scavenge conduit, a first valve plate constructed and arranged to control the flow of blowdown exhaust gas through the blowdown exhaust gas passage, a second valve plate constructed and arranged to control the flow of scavenge exhaust gas through the scavenge exhaust gas passage, and a third valve plate constructed and arranged to control the flow of exhaust gas from the blowdown exhaust gas passage through the wastegate passage and into the scavenge exhaust gas passage.

4. A product as set forth in claim 3 wherein the first valve plate, second valve plate and third valve plate are constructed and arranged to have a common axis of rotation.

5. A product as set forth in claim 4 further comprising a single actuator connected to the first valve plate, second valve plate and third valve plate to control the rotation thereof.

6. A product as set forth in claim 4 wherein the blowdown conduit and scavenge conduit have a common wall.

7. A product as set forth in claim 6 wherein the wastegate crossover passage is formed in the common wall.

8. A product as set forth in claim 1 further comprising a vehicle engine having a concentric-cam/phaser.

9. A product as set forth in claim 3 further comprising a vehicle engine that does not have a concentric-cam/phaser.

10. A method comprising:
providing a product comprising a scavenge conduit and a blowdown conduit, wherein the scavenge conduit and blowdown conduit have a common wall, a valve system received between the scavenge conduit and the blowdown conduit, and a wastegate crossover passage formed between the scavenge conduit and blowdown conduit, the valve system including a first valve plate constructed and arranged to control the flow of exhaust gas through the scavenge conduit, a second valve plate constructed and arranged to control the flow of exhaust gas through the blowdown conduit, and a third valve plate constructed and arranged to control the flow of wastegate crossover exhaust from the blowdown conduit into the scavenger conduit, the first valve plate, second valve plate and third valve plate having a common axis of rotation, and controlling the valve system comprising at least one of:
(a) moving the first valve plate to a position adjacent the common wall and so that the scavenger conduit passage is fully open, moving the second valve plate to a position adjacent the common wall so that the blowdown passage is fully open, and moving the third plate to completely close the wastegate crossover passage between the blowdown conduit and scavenge conduit;
(b) moving the first valve plate to a position adjacent the common wall so the scavenge passage is completely open, moving the second valve plate to a position adjacent the common wall, and moving the third valve plate to a position away from being parallel with the common wall to at least partially open the wastegate crossover passage;
(c) moving the first valve plate to at least partially block the scavenge conduit passage, moving the second valve plate to a position adjacent the common wall so that the blowdown passage is completely open and moving the third valve plate to block the crossover wastegate passage between the blowdown conduit and the scavenge conduit; or
(d) moving the first valve plate to a position adjacent the common wall so that the scavenge conduit passage is completely open, moving the second valve plate to at least partially restrict the flow of exhaust through the blowdown conduit passage, and moving the third valve plate to close the wastegate crossover passage between the blowdown conduit and the scavenge conduit.

11. A method as set forth in claim 10 further comprising a vehicle engine including a plurality of cylinders, a plurality of scavenge valves and a plurality of blowdown valves, wherein one of the plurality of scavenge valves and one of the plurality of blowdown valves is connected to one of the plurality of cylinders, a blowdown manifold connected to the plurality of blowdown valves and the blowdown conduit connected to the blowdown manifold, a scavenger manifold connected to the plurality of scavenge valves and the scavenge conduit connected to the scavenge manifold, the blowdown conduit connected to a turbine of a turbocharger, the scavenge manifold bypassing the turbine and connected to the blowdown conduit downstream of the turbine or connected to a pollution control device, an air intake conduit connected to a compressor of the turbocharger, and the air conduit connected from the compressor to an air intake manifold operatively connected to the plurality of cylinders, the engine including a non-concentric cam/phaser, and
controlling the amount of air intake boost from the turbine by modulating the non-concentric/cam phaser when the first valve plate is in a position adjacent the common wall, the second valve plate is in a position adjacent the common wall and wherein the third valve plate closes the wastegate crossover passage between the blowdown conduit and the scavenge conduit.

12. A method as set forth in claim 10 wherein the controlling the valve system comprising
moving the first valve plate to a position adjacent the common wall and so that the scavenger conduit passage is fully open, moving the second valve plate to a position adjacent the common wall so that the blowdown passage is fully open, and moving the third plate to completely close the wastegate crossover passage between the blowdown conduit and scavenge conduit.

13. A method as set forth in claim 10 wherein the controlling the valve system comprising
moving the first valve plate to a position adjacent the common wall so the scavenge passage is completely open, moving the second valve plate to a position adjacent the common wall, and moving the third valve plate to a position away from being parallel with the common wall to at least partially open the wastegate crossover passage.

14. A method as set forth in claim 10 wherein the controlling the valve system comprising
moving the first valve plate to at least partially block the scavenge conduit passage, moving the second valve plate to a position adjacent the common wall so that the blowdown passage is completely open and moving the third valve plate to block the crossover wastegate passage between the blowdown conduit and the scavenge conduit.

15. A method as set forth in claim 10 wherein the controlling the valve system comprising
moving the first valve plate to a position adjacent the common wall so that the scavenge conduit passage is completely open, moving the second valve plate to at least partially restrict the flow of exhaust through the blowdown conduit passage, and moving the third valve plate to close the wastegate crossover passage between the blowdown conduit and the scavenge conduit.
